(19) United States
(12) Patent Application Publication
(10) Pub. No.: US 2009/0125966 A1
(43) Pub. Date: May 14, 2009

(54) DIGITAL CABLE BROADCASTING RECEIVER INCLUDING SECURITY MODULE AND METHOD FOR AUTHENTICATING THE SAME

(76) Inventors: Yong Seong CHO, Daejeon (KR); O Hyung KWON, Daejeon (KR); Soo In LEE, Daejeon (KR)

Correspondence Address: LADAS & PARRY LLP, 224 SOUTH MICHIGAN AVENUE, SUITE 1600, CHICAGO, IL, 60604, US

(21) Appl. No.: 12/139,642

(22) Filed: Jun. 16, 2008

(30) Foreign Application Priority Data
Nov. 14, 2007 (KR) 10-2007-0116006

(51) Int. Cl. H04N 7/173

(52) U.S. Cl. 725/131

(57) ABSTRACT

A digital cable broadcasting receiver and a method of authenticating the digital cable broadcasting receiver, the digital cable broadcasting receiver includes: a security module unit to perform a device authentication process using two-way communication with a Head End (HE) system, and to transmit authentication verification information generated by the device authentication process to a receiver central processing unit (CPU); a demodulation unit to demodulate a broadcasting signal received from a tuner based on the authentication verification information, and to extract transport stream data; the receiver CPU to control power of the demodulation unit based on the authentication verification information; and a decoding unit to restore the transport stream data into image data.

### CROSS-REFERENCE TO RELATED APPLICATION

This application claims priority from Korean Patent Application No. 10-2007-0116006, filed on Nov. 14, 2007, in the Korean Intellectual Property Office, the entire disclosure of which is incorporated herein by reference.

### BACKGROUND OF THE INVENTION

1. Field of the Invention

The present invention relates to a digital cable broadcasting receiver and a method of authenticating the digital cable broadcasting receiver, and more particularly, to a digital cable broadcasting receiver that includes a security module for authentication to enable a broadcast to be watched only when the authentication with respect to the digital cable broadcasting receiver is verified, and a method of authenticating the digital cable broadcasting receiver.

This work was supported by the IT R&D program of MIC/IITA [2007-S-007-01, The Development of Downloadable Conditional Access System].

2. Description of Related Art

As broadcasting has been recently digitalized, many technologies to prevent broadcast programs from being illicitly watched and distributed are developed. A Conditional Access (CA) system for providing a paid broadcasting service performs scrambling encryption of a broadcast program, and transmits, to televiewers, key information used for a scrambling encryption process of the broadcast program using a wired network, thereby enabling only paid service subscribers having an authority of watching the broadcast program to watch the broadcast program. For this, the televiewers use smart cards or cards of a Personal Computer Memory Card International Association (PCMCIA) type inserted in a digital cable broadcasting receiver separate from the digital cable broadcasting receiver, or use cards of the PCMCIA type in an OpenCable scheme being a North American standard. However, when the scrambled broadcast program is received, the televiewers may watch a general broadcast even when a cable card to perform descrambling is not used, and the televiewers being non-subscribers of a cable broadcasting service may watch the general broadcast using a method of redirecting a broadcasting circuit and the like. Accordingly, enabling only the televiewers having a watching authority and being subscribers of the paid service to watch the broadcast program is difficult.

When the televiewers watch the broadcast without inserting the cable card in the digital cable broadcasting receiver, the televiewers may not watch a scrambled broadcast program, however, the televiewers may watch a non-scrambled broadcast program. Even when only the digital cable broadcasting receiver is included and the televiewers are non-subscribers of the broadcasting service, the televiewers may watch the broadcast program.

### SUMMARY OF THE INVENTION

An aspect of the present invention provides a digital cable broadcasting receiver and a method of authenticating the digital cable broadcasting receiver that enables a broadcast program to be watched only when authentication with respect to a subscriber is completed using a security module for authentication included in the digital cable broadcasting receiver.

Another aspect of the present invention also provides a digital cable broadcasting receiver including a security module for authentication that enables only a legitimate subscriber of a broadcasting service to watch a broadcast program and can prevent a non-subscriber of the broadcasting service from illicitly watching the broadcast program.

According to an aspect of the present invention, there is provided a digital cable broadcasting receiver including: a security module unit to perform a device authentication process using two-way communication with a Head End (HE) system, and to transmit authentication verification information generated by the device authentication process to a receiver central processing unit (CPU); a demodulation unit to demodulate a broadcasting signal received from a tuner based on the authentication verification information, and to extract transport stream data; the receiver CPU to control power of the demodulation unit based on the authentication verification information; and a decoding unit to restore the transport stream data into image data.

According to another aspect of the present invention, there is provided a digital cable broadcasting receiving system, the system including: a digital cable broadcasting receiver module to extract transport stream data from a broadcasting signal received from an HE system using a device authentication process with the HE system; and a separate Conditional Access (CA) module to descramble the transport stream data being inserted in the digital cable broadcasting receiving module and being received from the HE system, and to transmit the descrambled transport stream data to the digital cable broadcasting receiver module, wherein the digital cable broadcasting receiver module includes: a security module unit to perform the device authentication process using two-way communication with the HE system, and to transmit authentication verification information generated by the device authentication process to a receiver CPU; a demodulation unit to demodulate the broadcasting signal received from a tuner based on the authentication verification information, and to extract the transport stream data from the demodulated broadcasting signal; the receiver CPU to control power of the demodulation unit based on the authentication verification information; and a decoding unit to restore the transport stream data into image data.

According to still another aspect of the present invention, there is provided a method of authenticating a digital cable broadcasting receiver in a digital cable broadcasting receiving system, the method including: receiving, by a security module unit, a registration request command message from an HE system, verifying whether authentication verification information is stored, and determining whether the digital cable broadcasting receiver is authenticated; transmitting, to the HE system, a registration request command verification message corresponding to the registration request command message; transmitting an authentication request message to the HE system, and receiving, from the HE system, an authentication request verification message corresponding to the authentication request message when the digital cable broadcasting receiver is determined to be unauthenticated; and receiving a broadcasting signal based on the authentication request verification message.

According to yet another aspect of the present invention, there is provided a method of authenticating a digital cable broadcasting receiver in a security module unit to authenticate the digital cable broadcasting receiver, the method including: receiving a registration request command message from an HE system, verifying whether authentication verification information is stored, and determining whether the digital cable broadcasting receiver is authenticated; transmitting, to the digital cable broadcasting receiver, a registration request command verification message corresponding to the determination result; transmitting an authentication request message to the digital cable broadcasting receiver when the digital cable broadcasting receiver is determined to be unauthenticated; and transmitting, to the digital cable broadcasting receiver, an authentication verification completion message corresponding to an authentication request verification message received from the HE system.

### BRIEF DESCRIPTION OF THE DRAWINGS

The above and other aspects of the present invention will become apparent and more readily appreciated from the following detailed description of certain exemplary embodiments of the invention, taken in conjunction with the accompanying drawings of which:

FIG. 1 is a block diagram illustrating a digital cable broadcasting receiving system including a digital cable broadcasting receiver according to an exemplary embodiment of the present invention;

FIG. 2 is a block diagram illustrating a security module unit included in the digital cable broadcasting receiver module of FIG. 1;

FIG. 3 is a flowchart illustrating a method of authenticating a digital cable broadcasting receiver in a digital cable broadcasting receiving system according to an exemplary embodiment of the present invention;

FIG. 4 is a flowchart illustrating an authentication process with respect to a digital cable broadcasting receiver between the digital cable broadcasting receiver including a security module unit and a digital broadcasting Head End (HE) system according to an exemplary embodiment of the present invention; and

FIG. 5 is a flowchart illustrating a method of authenticating a digital cable broadcasting receiver in a security module unit for authentication according to an exemplary embodiment of the present invention.

### DETAILED DESCRIPTION OF EXEMPLARY EMBODIMENTS

Reference will now be made in detail to exemplary embodiments of the present invention, examples of which are illustrated in the accompanying drawings, wherein like reference numerals refer to the like elements throughout. The exemplary embodiments are described below in order to explain the present invention by referring to the figures.

Hereinafter, a digital cable broadcasting receiver including a security module for authentication and a method of authenticating the digital cable broadcasting receiver according to an exemplary embodiment of the present invention are described in detail with reference to the attached drawings. When detailed descriptions related to a well-known related function or configuration are determined to make the spirits of the present invention ambiguous, the detailed descriptions will be omitted herein. Also, terms used throughout the present specification are used to appropriately describe exemplary embodiments of the present invention, and thus may be different depending upon a user and an operator's intention, or practices of application fields of the present invention. Therefore, the terms must be defined based on descriptions made through the present invention.

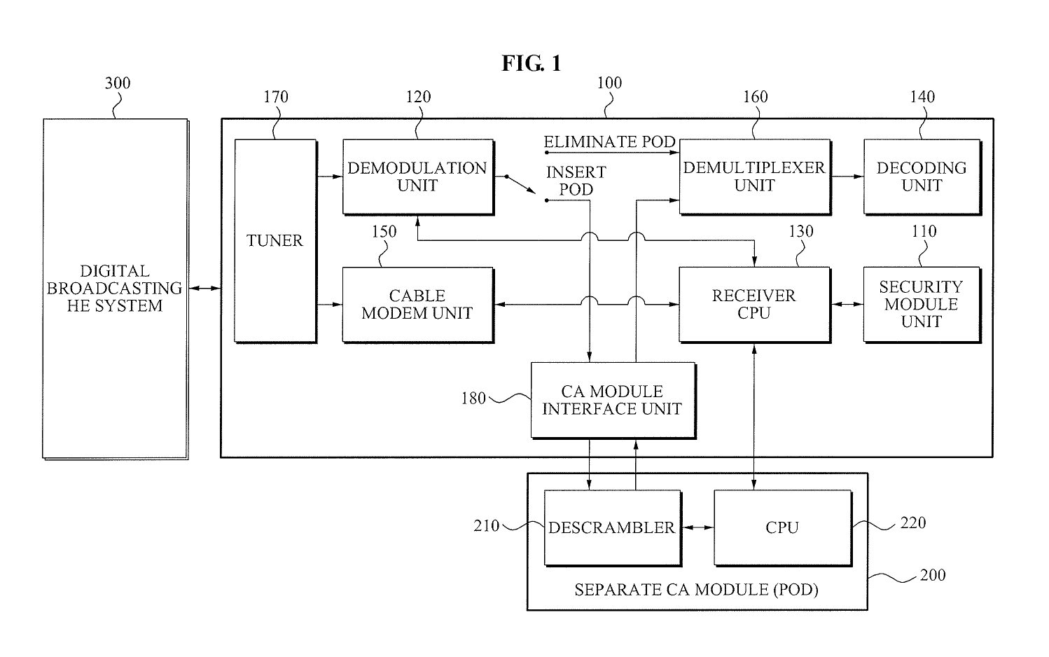

FIG. 1 is a block diagram illustrating a digital cable broadcasting receiving system including a digital cable broadcasting receiver according to an exemplary embodiment of the present invention.

Referring to FIG. 1, the digital cable broadcasting receiving system according to an exemplary embodiment of the present invention includes a digital cable broadcasting receiver module 100 and a separate Conditional Access (CA) module 200.

Additional broadcasting-related information received from a Head End (HE) system 300 is transmitted to a receiver central processing unit (CPU) 130 via a tuner 170 and a cable modem unit 150, and messages related to authentication from among the additional broadcasting-related information are transmitted to a security module unit 110. The security module unit 110 performs a device authentication process using two-way communication with the HE system 300, determines authentication concerning whether the digital cable broadcasting receiver module 100 is a device of a legitimate subscriber of a broadcasting service is performed, and transmits the determination result to the receiver CPU 130. The receiver CPU 130 controls an output of a demodulation unit 120 using a specific signal of the demodulation unit 120 based on the authentication determination result.

The digital cable broadcasting receiver module 100 extracts transport stream data from a broadcasting signal received from the HE system 300 using the process authentication process with the digital broadcasting HE system 300. The transport stream data may be Motion Picture Experts Group-2 Transport Stream (MPEG-2 TS) data. The separate CA module 200 is inserted in the digital cable broadcasting receiver module 100, descrambles the transport stream data received from the HE system 300, and transmits the descrambled transport stream data to the digital cable broadcasting receiver module 100. The separate CA module 200 may be a cable card of a Point of Deployment (POD) scheme, and may embody two-way communication with the digital cable broadcasting receiver module 100 using a CA module interface unit 180 of the digital cable broadcasting receiver module 100. The separate CA module 200 includes a descrambler 210 to descramble the scrambled broadcasting signal and a CPU 220 for CA processing.

For this, the digital cable broadcasting receiver module 100 includes the security module unit 110, the demodulation unit 120, the receiver CPU 130, and a decoding unit 140. The demodulation unit 120 demodulates the broadcasting signal received from the tuner 170 based on the authentication verification information, and extracts transport stream data, and the receiver CPU 130 controls power of the demodulation unit 120 based on the authentication verification information. The demodulation unit 120 according to an exemplary embodiment of the present invention may be a demodulation unit of a Quadrature Amplitude Modulation (QAM) scheme. The decoding unit 140 restores the transport stream data into image data.

The security module unit 110 performs the device authentication process using two-way communication with the HE system 300, and transmits the authentication verification information generated by the device authentication process to the receiver CPU 130. The security module unit 110 receives, from the HE system 300, a registration request command message with respect to the digital cable broadcasting receiver module 100, verifies whether the authentication verification information is stored, determines whether the digital cable broadcasting receiver module 100 is authenticated, and transmits, to the HE system 300, a registration request command verification message corresponding to the determination result. The registration request command verification message includes information about whether the digital cable broadcasting receiver is authenticated and/or unique security module information.

Specifically, when the digital cable broadcasting receiver module 100 is determined to be unauthenticated, the security module unit 110 generates an authentication request message including the unique security module information and/or unique broadcasting receiver information, encrypts the authentication request message, transmits the encrypted authentication request message to the HE system 300, receives, from the HE system 300, an authentication request verification message corresponding to the authentication request message, decrypts the authentication request verification message, determines whether the authentication verification information is included in the decrypted authentication request verification message. When the authentication verification information is included, the security module unit 110 stores and maintains the authentication verification information. The authentication request verification message includes the unique security module information, the unique broadcasting receiver information, and the authentication verification information.

The security module unit 110 transmits, to the receiver CPU 130, an authentication verification completion message corresponding to the authentication verification information, and the receiver CPU 130 activates an output of the demodulation unit 120 based on the authentication verification information. Accordingly, the digital cable broadcasting receiver module 100 may receive the broadcasting signal.

The digital cable broadcasting receiver module 100 according to an exemplary embodiment of the present invention may include a cable modem unit 150 to receive digital cable broadcasting information from the HE system 300, and to transmit authentication-related information to the HE system 300, and a demultiplexer unit 160 to process the transport stream data received from the demodulation unit 120, and to transmit the transport stream data to the decoding unit 140.

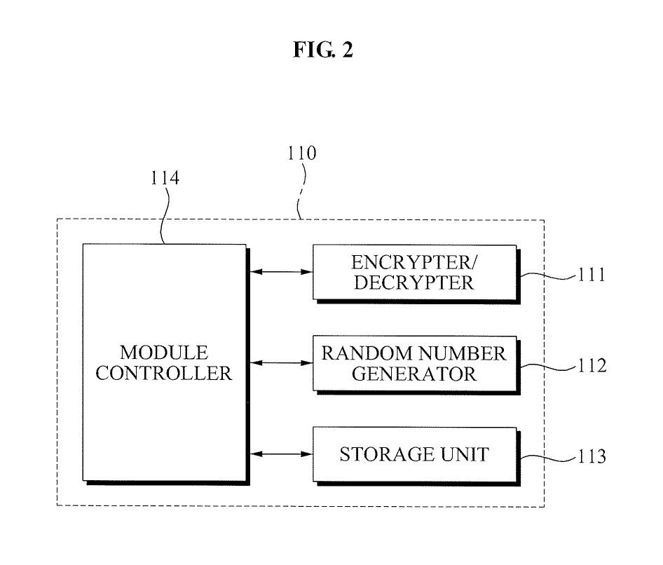

Hereinafter, referring to FIG. 2, the security module unit 110 according to an exemplary embodiment of the present invention is described in detail.

FIG. 2 is a block diagram illustrating a security module unit included in the digital cable broadcasting receiver module 100 of FIG. 1.

Referring to FIG. 2, the security module unit 110 according to an exemplary embodiment of the present invention includes an encrypter/decrypter 111 to encrypt/decrypt a message transceived from/to the receiver CPU 130 using the device authentication process, a random number generator 112 to generate a random number for an encryption/decryption key to encrypt/decrypt the message, a storage unit 113 to temporarily store the message and/or the encryption/decryption key, and to store and control the authentication verification information, and a module controller 114 to control transceiving of the message from/to the receiver CPU 130, and to control the device authentication process. The storage unit 113 includes a flash memory, an Electrically Erasable Programmable Read-Only Memory (EEPROM), or a static random access memory (SRAM).

The message received from the receiver CPU 130 is decrypted by the encrypter/decrypter 111, the decrypted message is transmitted to the module controller 114, and the device authentication process with the HE system 300 described with reference to FIG. 1 is performed. In this case, the message transmitted to the HE system 300 is encrypted by the encrypter/decrypter 111, and is transmitted to the HE system 300 via the module controller 114, the receiver CPU 130, and the cable modem unit 150.

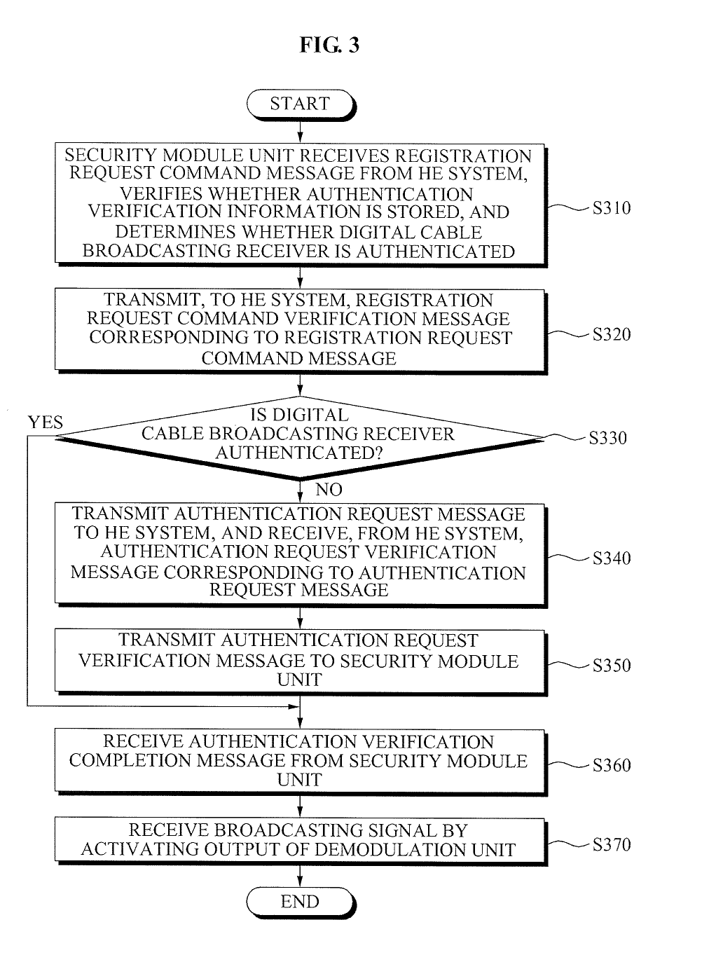

FIG. 3 is a flowchart illustrating a method of authenticating a digital cable broadcasting receiver in a digital cable broadcasting receiving system according to an exemplary embodiment of the present invention.

Referring to FIG. 3, in operation S310, a security module unit receives a registration request command message from a digital broadcasting HE system, verifies whether authentication verification information is stored, and determines whether the digital cable broadcasting receiver is authenticated.

In operation S320, the method transmits, to the HE system, a registration request command verification message corresponding to the registration request command message. The registration request command verification message includes information about whether the digital cable broadcasting receiver is authenticated and/or unique security module information.

When the digital cable broadcasting receiver is determined to be unauthenticated in operation S330 based on the determining of whether the digital cable broadcasting receiver is authenticated in operation S310, the method transmits an authentication request message to the HE system, and receives, from the HE system, an authentication request verification message corresponding to the authentication request message in operation S340. The authentication request message includes the unique security module information and/or unique broadcasting receiver information. In operation S350, the method transmits the authentication request verification message to the security module unit. In operation S360, the method receives the broadcasting signal by receiving, from the security module unit, an authentication verification completion message corresponding to the authentication request verification message. In operation S370, the method receives the broadcasting signal by activating an output of a demodulation unit of a QAM scheme, the demodulation unit being a demodulation unit of the digital cable broadcasting receiver. The authentication request verification message includes the unique security module information, the unique broadcasting receiver information, and the authentication verification information.

Conversely, when the digital cable broadcasting receiver is determined to be authenticated in operation S330 based on the determining of whether the digital cable broadcasting receiver is authenticated in operation S310, the method receives the broadcasting signal based on the authentication verification information. In operation S360, the method receives, from the security module unit, an authentication verification completion message corresponding to the authentication request verification message. In operation S370, the method receives the broadcasting signal by activating the output of the demodulation unit of the digital cable broadcasting receiver.

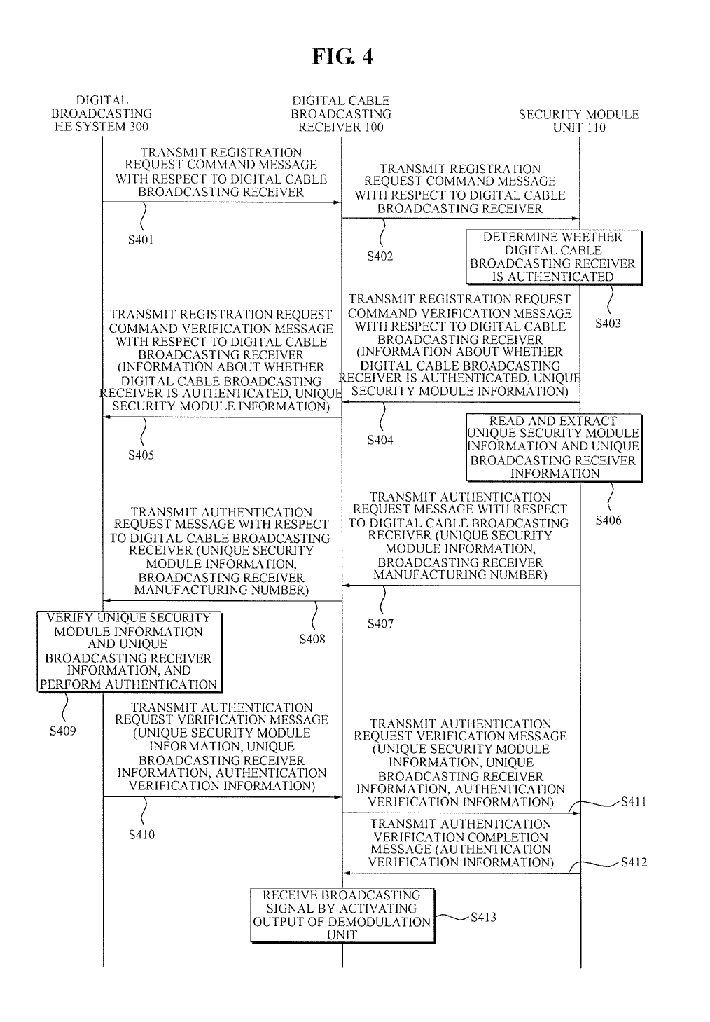

FIG. 4 is a flowchart illustrating an authentication process with respect to a digital cable broadcasting receiver 100 between the digital cable broadcasting receiver 100 including a security module unit 110 and a digital broadcasting HE system 300 according to an exemplary embodiment of the present invention.

Referring to FIG. 4, in operation S401, the digital cable broadcasting receiver 100, and more particularly, a receiver CPU of the digital cable broadcasting receiver 100 receives a registration request command message from the digital broadcasting HE system 300. In operation S402, the digital cable broadcasting receiver 100 transmits the registration request command message to the security module unit 110. In operation S403, the security module unit 110 determines whether the digital cable broadcasting receiver is authenticated.

In operation S405, the security module unit 110 having received the registration request command message includes information about whether the digital cable broadcasting receiver 100 is authenticated and unique security module information such as security module identification information in a registration request command verification message, and transmits the registration request command verification message to the HE system 300 via the digital cable broadcasting receiver 100 in operation S404.

When the digital cable broadcasting receiver 100 is already authenticated and authentication verification information is maintained, operations S406 through S411 are not performed. After an authentication verification completion message including the authentication verification information is transmitted to the digital cable broadcasting receiver 100 in operation S412, the normal digital cable broadcasting receiver 100 to receive a broadcasting signal by activating an output of a demodulation unit of the digital cable broadcasting receiver 100 operates.

Conversely, in operation S406, when the digital cable broadcasting receiver 100 is determined to be unauthenticated such as a case where the digital cable broadcasting receiver 100 initially accesses the digital broadcasting HE system 300 based on determining whether the digital cable broadcasting receiver 100 is authenticated, the method reads and extracts the unique security module information and unique broadcasting receiver information such as a manufacturing number of the digital cable broadcasting receiver 100 from the security module unit 110.

In operation S408, the method transmits an authentication request message including the unique security module information such as a security module identifier and/or the broadcasting receiver manufacturing number to the digital broadcasting HE system 300 via the digital cable broadcasting receiver 100 in operation S407. In operation S409, the digital broadcasting HE system 300 having received the authentication request message compares the unique security module information (the identifier) and the unique broadcasting receiver information (the manufacturing number), and broadcasting subscriber registration information of the digital broadcasting HE system 300, verifies whether the digital cable broadcasting receiver 100 is a legitimate subscriber of a broadcasting service, and subsequently performs a device authentication process.

In operation S411, the digital broadcasting HE system 300 transmits the authentication request verification message including the unique security module information, the unique broadcasting receiver information, and the authentication verification information to the security module unit 110 via the digital cable broadcasting receiver 100 in operation S410. In operation S412, the security module unit 110 having received the authentication request verification message stores the authentication verification information included in the authentication request verification message in a predetermined storage unit, generates the authentication request verification message including the authentication verification information, and transmits the authentication request verification message to the digital cable broadcasting receiver 100. In operation S413, the digital cable broadcasting receiver 100 starts a normal operation to receive the broadcasting signal by activating an output of a demodulation unit.

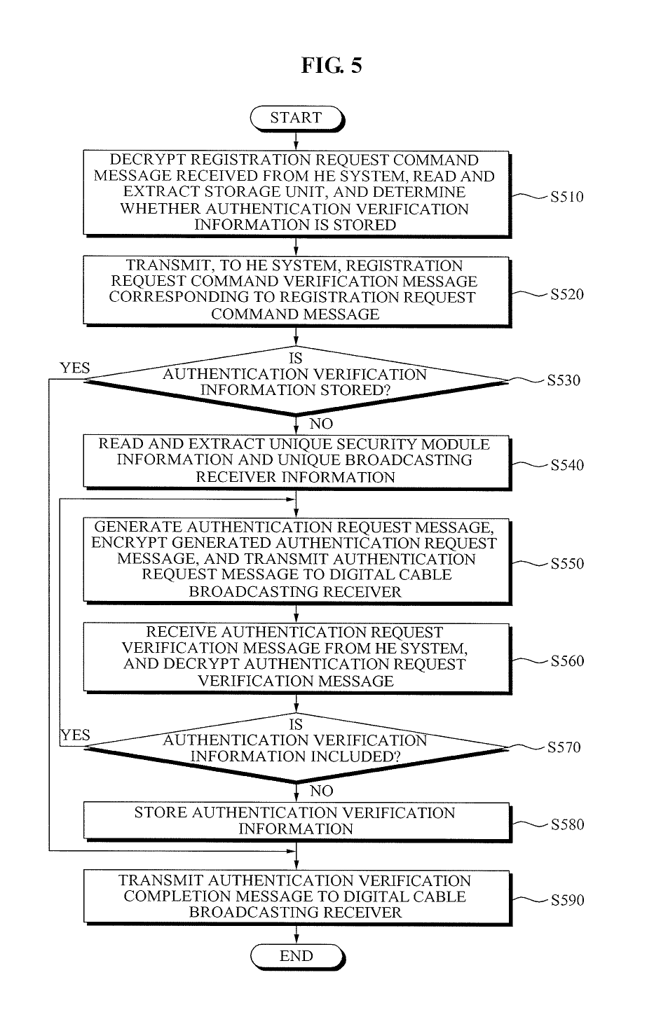

FIG. 5 is a flowchart illustrating a method of authenticating a digital cable broadcasting receiver in a security module unit for authentication according to an exemplary embodiment of the present invention.

Referring to FIG. 5, in operation S510, the method receives a registration request command message from a digital broadcasting HE system, verifies whether authentication verification information is stored, and determines whether the digital cable broadcasting receiver is authenticated. Specifically, in operation S510, the method decrypts the encrypted registration request command message received from the digital broadcasting HE system, reads and extracts authentication verification information from a storage unit, and determines whether the authentication verification information is stored.

In operation S520, the security module unit having received the registration request command message transmits, to the HE system, a registration request command verification message corresponding to the registration request command message. The registration request command verification message includes information about whether the digital cable broadcasting receiver is authenticated and/or unique security module information.

In operation S530, the method determines whether the authentication verification information is stored in a storage unit based on the determining of whether the digital cable broadcasting receiver is authenticated in operation S510. In operation S540, when the digital cable broadcasting receiver is unauthenticated, the method reads and extracts the unique security module information and/or unique broadcasting receiver information. In operation S550, the method generates the authentication request message including the read and extracted unique security module information and/or the read and extracted unique broadcasting receiver information, encrypts the generated authentication request message, and transmits the authentication request message to the digital cable broadcasting receiver.

The digital broadcasting HE system having received the authentication request message compares the unique security module information and the unique broadcasting receiver information, and broadcasting subscriber registration information of the digital broadcasting HE system, verifies whether the digital cable broadcasting receiver is a legitimate subscriber of a broadcasting service, subsequently performs a device authentication process, and subsequently receives an authentication request verification message corresponding to the authentication request message received from the HE system to the digital cable broadcasting receiver. In operation S560, since the authentication request verification message received from the digital broadcasting HE system is encrypted, the method decrypts the authentication request verification message. The authentication request verification message includes the unique security module information, the unique broadcasting receiver information, and the authentication verification information.

In operation S570, the security module unit determines whether the authentication verification information is included in the authentication request verification message. In operation S580, when the authentication verification information is included, the security module unit stores the authentication verification information in the storage unit. In operation S590, the security module unit transmits an authentication verification completion message to the digital cable broadcasting receiver. The authentication request verification message includes the unique security module information, the unique broadcasting receiver information, and the authentication verification information. However, when the authentication verification information is excluded from the authentication request verification message in operation S570, the method proceeds to operation S550, and retransmits the authentication request message for a device authentication process to the digital broadcasting HE system.

Conversely, in operation S590, when the digital cable broadcasting receiver is authenticated and the authentication verification information exists based on the determining of whether the digital cable broadcasting receiver is authenticated in operation S530, the security module unit transmits an authentication verification completion message including the unique security module information, the unique broadcasting receiver information, and the authentication verification information.

After completing the device authentication process, the digital cable broadcasting receiver having received the authentication verification completion message corresponding to the authentication request verification message from the security module unit receives the broadcasting signal. Specifically, the digital cable broadcasting receiver receives the broadcasting signal by activating an output of a demodulation unit of the digital cable broadcasting receiver.

The method of authenticating the digital cable broadcasting receiver including a security module according to the above-described exemplary embodiments may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

According to the present invention, there is provided a digital cable broadcasting receiver and a method of authenticating the digital cable broadcasting receiver that enables a broadcast program to be watched only when authentication with respect to a subscriber is completed using a security module for authentication included in the digital cable broadcasting receiver.

Also, according to the present invention, there is provided a digital cable broadcasting receiver including a security module for authentication that enables only a legitimate subscriber of a broadcasting service to watch a broadcast program and can prevent a non-subscriber of the broadcasting service from illicitly watching the broadcast program.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A digital cable broadcasting receiver comprising:
a security module unit to perform a device authentication process using two-way communication with a Head End (HE) system, and to transmit authentication verification information generated by the device authentication process to a receiver central processing unit (CPU);
a demodulation unit to demodulate a broadcasting signal received from a tuner based on the authentication verification information, and to extract transport stream data;
the receiver CPU to control power of the demodulation unit based on the authentication verification information; and
a decoding unit to restore the transport stream data into image data.

2. The digital cable broadcasting receiver of claim 1, further comprising:
a cable modem unit to receive digital cable broadcasting information from the HE system, and to transmit authentication-related information to the HE system.

3. The digital cable broadcasting receiver of claim 1, further comprising:
a demultiplexer unit to process the transport stream data received from the demodulation unit, and to transmit the transport stream data to the decoding unit.

4. The digital cable broadcasting receiver of claim 1, wherein the security module unit receives, from the HE system, a registration request command message with respect to the digital cable broadcasting receiver, verifies whether the authentication verification information is stored, determines whether the digital cable broadcasting receiver is authenticated, and transmits, to the HE system, a registration request command verification message corresponding to the determination result.

5. The digital cable broadcasting receiver of claim 4, wherein the registration request command verification message includes information about whether the digital cable broadcasting receiver is authenticated and/or unique security module information.

6. The digital cable broadcasting receiver of claim 4, wherein, when the digital cable broadcasting receiver is determined to be unauthenticated, the security module unit generates an authentication request message including unique security module information and/or unique broadcasting receiver information, encrypts the authentication request message, and transmits the encrypted authentication request message to the HE system.

7. The digital cable broadcasting receiver of claim 1, wherein the security module unit receives, from the HE system, an authentication request verification message corresponding to an authentication request message, decrypts the authentication request verification message, determines whether the authentication verification information is included in the decrypted authentication request verification message, and stores the authentication verification information.

8. The digital cable broadcasting receiver of claim 7, wherein the security module unit transmits, to the receiver CPU, an authentication verification completion message corresponding to the authentication verification information, and
the receiver CPU activates an output of the demodulation unit based on the authentication verification information.

9. The digital cable broadcasting receiver of claim 7, wherein the authentication request verification message includes unique security module information, unique broadcasting receiver information, and the authentication verification information.

10. The digital cable broadcasting receiver of claim 1, wherein security module unit comprises:
an encrypter/decrypter to encrypt/decrypt a message transceived from/to the receiver CPU using the device authentication process;
a random number generator to generate a random number for an encryption/decryption key to encrypt/decrypt the message;
a storage unit to temporarily store the message and/or the encryption/decryption key, and to store and control the authentication verification information; and
a module controller to control transceiving of the message from/to the receiver CPU, and to control the device authentication process.

11. A method of authenticating a digital cable broadcasting receiver in a digital cable broadcasting receiving system, the method comprising:
receiving, by a security module unit, a registration request command message from an HE system, verifying whether authentication verification information is stored, and determining whether the digital cable broadcasting receiver is authenticated;
transmitting, to the HE system, a registration request command verification message corresponding to the registration request command message;
transmitting an authentication request message to the HE system, and receiving, from the HE system, an authentication request verification message corresponding to the authentication request message when the digital cable broadcasting receiver is determined to be unauthenticated; and
receiving a broadcasting signal based on the authentication request verification message.

12. The method of claim 11, further comprising:
receiving the broadcasting signal based on the authentication verification information when the digital cable broadcasting receiver is determined to be authenticated.

13. The method of claim 11, wherein the receiving of the broadcasting signal receives the broadcasting signal by transmitting the authentication request verification message to the security module unit and receiving, from the security module unit, an authentication verification completion message corresponding to the authentication request verification message.

14. The method of claim 11, wherein the registration request command verification message includes information about whether the digital cable broadcasting receiver is authenticated and/or unique security module information.

15. The method of claim 11, wherein the authentication request message includes unique security module information and/or unique broadcasting receiver information.

16. The method of claim 12, wherein the receiving of the broadcasting signal based on the authentication request verification message receives the broadcasting signal by activating an output of a demodulation unit of the digital cable broadcasting receiver.

17. The method of claim 12, wherein the authentication request verification message includes unique security module information, unique broadcasting receiver information, and the authentication verification information.

18. A method of authenticating a digital cable broadcasting receiver in a security module unit to authenticate the digital cable broadcasting receiver, the method comprising:
receiving a registration request command message from an HE system, verifying whether authentication verification information is stored, and determining whether the digital cable broadcasting receiver is authenticated;
transmitting, to the digital cable broadcasting receiver, a registration request command verification message corresponding to the determination result;
transmitting an authentication request message to the digital cable broadcasting receiver when the digital cable broadcasting receiver is determined to be unauthenticated; and
transmitting, to the digital cable broadcasting receiver, an authentication verification completion message corresponding to an authentication request verification message received from the HE system.

19. The method of claim 18, wherein the receiving, verifying, and determining comprises:
decrypting the registration request command message, reading and extracting authentication verification information from a storage unit, and determining whether the authentication verification information exists.

20. The method of claim 18, wherein the transmitting of the authentication request message comprises:
generating the authentication request message including unique security module information and/or unique broadcasting receiver information, encrypting the generated authentication request message, and transmitting the authentication request message to the digital cable broadcasting receiver.

21. The method of claim 18, wherein the authentication request verification message includes unique security module information, unique broadcasting receiver information, and the authentication verification information, and
the transmitting of the authentication verification completion message comprises:
decrypting the authentication request verification message, and determining whether the authentication verification information is included in the decrypted authentication request verification message; and
storing the authentication verification information in a storage unit when the authentication verification information is included.

22. The method of claim 18, further comprising:
transmitting the authentication verification completion message to the digital cable broadcasting receiver when the digital cable broadcasting receiver is determined to be authenticated.
